(19) United States
(12) Patent Application Publication
(10) Pub. No.: US 2012/0237670 A1
(43) Pub. Date: Sep. 20, 2012

(54) FABRICATING METHOD OF SOLAR CELL

(75) Inventors: JungWook Lim, Daejeon (KR); Seong Hyun Lee, Busan (KR); Da Jung Lee, Gumi-si (KR); Sun Jin Yun, Daejeon (KR)

(73) Assignee: ELECTRONICS AND TELECOMMUNICATIONS RESEARCH INSTITUTE, Daejeon (KR)

(21) Appl. No.: 13/401,867

(22) Filed: Feb. 22, 2012

(30) Foreign Application Priority Data
Mar. 15, 2011 (KR) 10-2011-0023022
May 26, 2011 (KR) 10-2011-0050311

(51) Int. Cl. B05D 5/00

(52) U.S. Cl. 427/74

(57) ABSTRACT

Provided are fabricating methods of a solar cell capable of displaying a predetermined color. The method includes forming a first electrode on a substrate and forming a light-absorbing layer on the first electrode. The light-absorbing layer may have a composition ratio, a content of the amorphous portion, or an energy bandgap controlled to absorb a light with a predetermined wavelength. In addition, selective transmission layers may be formed on and below the light-absorbing layer to control the color displayed by the solar cell. Furthermore, a second electrode may be formed on the light-absorbing layer.

### CROSS-REFERENCE TO RELATED APPLICATIONS

This U.S. non-provisional patent application claims priority under 35 U.S.C. §119 to Korean Patent Application Nos. 10-2011-0023022 and 10-2011-0050311, filed on Mar. 15, 2011 and May 26, 2011, respectively, in the Korean Intellectual Property Office, the entire contents of which are hereby incorporated by reference.

### BACKGROUND OF THE INVENTION

Embodiments of the inventive concepts relate generally to a method of fabricating a solar cell, and more particularly, to fabricating methods of a solar cell capable of displaying a predetermined color.

To meet growing energy needs, there has been developed a solar cell technology for converting a solar energy into an electric energy. For example, by virtue of increasing photoelectric efficiency of the solar cell, it is possible to realize a building integrated photovoltaic (BIPV) system including (semi) transparent solar cell modules, which are configured to replace the conventional windows or roofs.

### SUMMARY

Embodiments of the inventive concepts provide fabricating methods of a solar cell capable of displaying a predetermined color.

According to example embodiments of the inventive concepts, a method of fabricating a solar cell may include providing a substrate, forming a first electrode on the substrate, forming a light-absorbing layer on the first electrode. The light-absorbing layer may have a composition ratio or an energy bandgap controlled to absorb a light with a predetermined wavelength.

In some embodiments, the light-absorbing layer may be formed of at least one of silicon, silicon nitride, silicon oxide, silicon carbide, or silicon germanium.

In some embodiments, the first and second electrodes may be formed to have a thickness of about 200 nm to about 1000 nm.

In some embodiments, the method may further include forming a first selective transmission layer between the substrate and the first electrode. The first selective transmission layer may allow a light in a predetermined range of wavelength to pass therethrough and transmit to the light-absorbing layer. The first selective transmission layer may be formed of a material having an energy bandgap of 2.5 eV or more. For example, the first selective transmission layer may be formed of at least one of SiO₂, Al₂O₃, TiO₂, AlTiO, or HfO₂.

In some embodiments, the method may further include forming a second selective transmission layer on the second electrode. The second selective transmission layer may allow a light in a predetermined range of wavelength to pass therethrough and be incident to the second electrode. The second selective transmission layer may be formed of a material having an energy bandgap of 2.5 eV or more. For example, the second selective transmission layer may be formed of at least one of SiO₂, Al₂O₃, TiO₂, AlTiO, or HfO₂.

According to other example embodiments of the inventive concepts, a method of fabricating a solar cell may include providing a substrate, forming a first electrode on the substrate, forming a light-absorbing layer including an amorphous portion on the first electrode, the light-absorbing layer having a content of the amorphous portion or an energy bandgap controlled to absorb a light with a predetermined wavelength, and forming a second electrode on the light-absorbing layer.

In some embodiments, the light-absorbing layer may include a crystalline silicon portion and an amorphous silicon portion, and a content ratio of the crystalline silicon portion to the amorphous silicon portion may be controlled in such a way that an energy bandgap of the light-absorbing layer may be in a range from about 0.7 eV to about 2.5 eV.

In some embodiments, the method may further include forming a first selective transmission layer between the substrate and the first electrode. The first selective transmission layer may allow a light in a predetermined range of wavelength to pass therethrough and transmit to the light-absorbing layer. The first selective transmission layer may be formed of a material having an energy bandgap of 2.5 eV or more. For example, the first selective transmission layer may be formed of at least one of SiO₂, Al₂O₃, TiO₂, AlTiO, or HfO₂.

In some embodiments, the method may further include forming a second selective transmission layer on the second electrode. The second selective transmission layer may allow a light in a predetermined range of wavelength to pass therethrough and be incident to the second electrode. The second selective transmission layer may be formed of a material having an energy bandgap of 2.5 eV or more. For example, the second selective transmission layer may be formed of at least one of SiO₂, Al₂O₃, TiO₂, AlTiO, or HfO₂.

### BRIEF DESCRIPTION OF THE DRAWINGS

Example embodiments will be more clearly understood from the following brief description taken in conjunction with the accompanying drawings. FIGS. 1 through 10 represent non-limiting, example embodiments as described herein.

FIG. 1 is a flow chart illustrating a method of fabricating a solar cell according to example embodiments of the inventive concepts;

FIGS. 2 through 5 are sectional views illustrating a method of fabricating a solar cell according to a first embodiment of the inventive concepts;

FIG. 6 is a sectional view of a solar cell according to a second embodiment of the inventive concepts;

FIG. 7 is a graph illustrating optical absorbance characteristics of a solar cell according to example embodiments of the inventive concepts;

FIG. 8 is a flow chart illustrating a method of fabricating a solar cell according to other example embodiments of the inventive concepts; and

FIGS. 9 and 10 are sectional views illustrating a method of fabricating a solar cell according to a third embodiment of the inventive concepts.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms.

These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

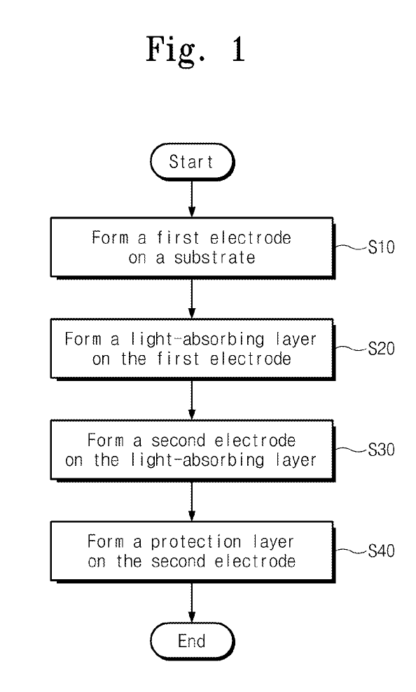

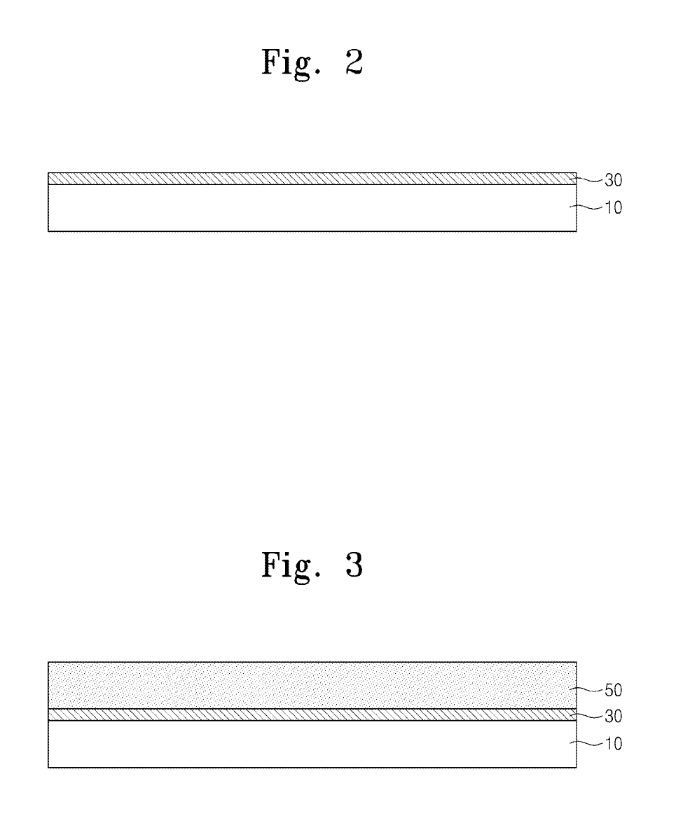

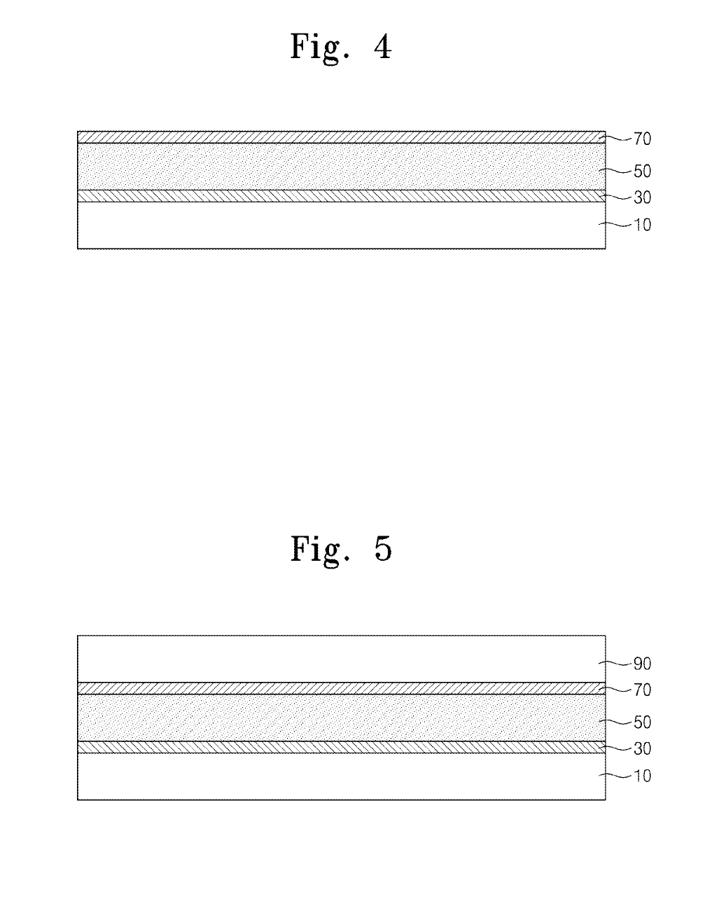

FIG. 1 is a flow chart illustrating a method of fabricating a solar cell according to example embodiments of the inventive concepts, and FIGS. 2 through 5 are sectional views illustrating a method of fabricating a solar cell according to a first embodiment of the inventive concepts, and FIG. 6 is a sectional view of a solar cell according to a second embodiment of the inventive concepts.

### First Embodiment

Hereinafter, a method of fabricating a solar cell according to a first embodiment of the inventive concepts will be described with reference to FIGS. 1 through 5.

Referring to FIGS. 1 and 2, a substrate 10 may be provided. The substrate 10 may be formed of a material including at least one of glass, ceramic, stainless steel, soda lime glass or polymer. In addition, the substrate 10 may be formed of a transparent material. Thereafter, a first electrode 30 may be formed on the substrate 10 (Step S10). The first electrode 30 may be formed of a transparent conductive material. For example, the first electrode 30 may be formed of at least one of zinc oxide (ZnO), tin oxide (SnO₂), indium tin oxide (ITO), gallium-doped zinc oxide (ZnO:Ga), boron-doped zinc oxide (ZnO:B), or aluminum-doped zinc oxide (AZO). In addition, the first electrode 30 may be formed to have a thickness of about 200 nm to about 1000 nm. For example, the first electrode 30 may be formed on the substrate 10 using at least one of a thermal vapor deposition, an electron beam deposition, a radio-frequency (RF) or magnetron sputtering method, and a chemical deposition.

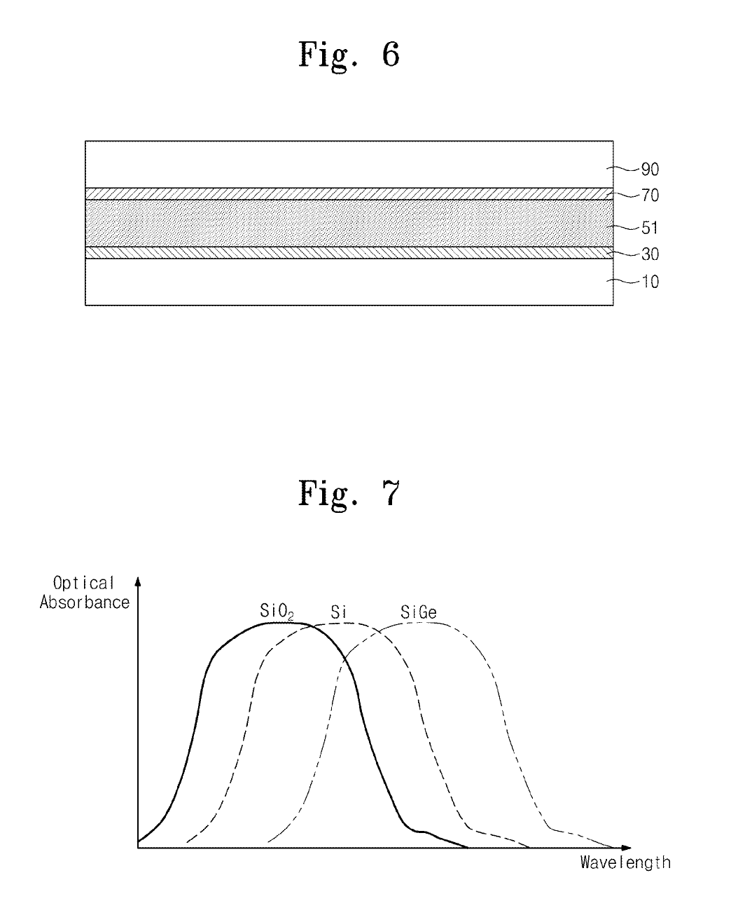

Referring to FIGS. 1 and 3, a light-absorbing layer 50 may be formed on the first electrode 30 (Step S20). The light-absorbing layer 50 may be a thin film of silicon or silicon compound and may be formed using a deposition process, such as a plasma-enhanced chemical vapor deposition (PECVD), a photo CVD, or a sputtering deposition. Here, the silicon compound film for the light-absorbing layer 50 may be at least one of silicon oxide, silicon carbide, silicon nitride or silicon germanium. In some embodiments, an energy bandgap of the light-absorbing layer 50 may be adjusted by changing a composition ratio of the silicon compound. For example, an energy bandgap of silicon oxide can be adjusted to a range of 1.8 eV to 2.5 eV by changing a composition ratio between silicon and oxygen, and an energy bandgap of silicon nitride can be adjusted to a range of 1.8 eV to 2.5 eV by changing a composition ratio between silicon and nitrogen. Furthermore, an energy bandgap of silicon carbide can be adjusted to a range of 1.8 eV to 2.5 eV by changing a composition ratio between silicon and carbon, and an energy bandgap of silicon germanium can be adjusted to a range of 0.7 eV to 2.0 eV by changing a composition ratio between silicon and germanium. The light-absorbing layer 50 may exhibit an optical absorbance property depending on materials used therefor; for example, in the cases in which silicon oxide, silicon and silicon germanium are used for the light-absorbing layer 50, a wavelength band absorbed by the light-absorbing layer 50 may be different from each other, as shown in FIG. 7. The wavelength band mainly absorbed by the light-absorbing layer 50 is lower for the case of silicon oxide than for the case of silicon, while the optical absorbance property of the silicon oxide layer can be adjusted by changing the composition ratio between silicon and oxygen. In addition, the wavelength band mainly absorbed by the light-absorbing layer 50 is higher for the case of silicon germanium than for the case of silicon, while the optical absorbance property of the silicon germanium layer can be adjusted by changing the composition ratio between silicon and germanium. In some embodiments, the composition ratio of silicon compound may be controlled by adjusting a condition or environment of a deposition process for forming the light-absorbing layer 50. For example, the composition ratio of silicon oxide layer may be controlled by changing flow rates of gases (for example, a silane gas (SiH4), an oxygen-containing gas, and a hydrogen gas).

Referring to FIGS. 1 and 4, a second electrode 70 may be formed on the light-absorbing layer 50 (Step S30). In some embodiments, the second electrode 70 may be formed of the substantially same material and by the substantially same method as the first electrode 30 described with reference to FIG. 2. Furthermore, the second electrode 70 may be formed to have the substantially same thickness as the first electrode 30.

Referring to FIGS. 1 and 5, a protection layer 90 may be formed on the second electrode 70 (Step S40). In some embodiments, the protection layer 90 may be formed of the substantially same material as the substrate 10 described with reference to FIG. 2.

Hereinafter, a method of fabricating a solar cell according to a second embodiment of the inventive concepts will be described with reference to FIGS. 1 and 6. For the sake of brevity, the elements and features of this embodiment that are similar to those previously shown and described with reference to FIGS. 2 through 5 will not be described in much further detail.

### Second Embodiment

Referring to FIGS. 1 and 6, a method of fabricating a solar cell may include providing the substrate 10 and forming the first electrode 30 on the substrate 10 (Step S10). A light-absorbing layer 51 may be formed on the first electrode 30 (Step S20). The light-absorbing layer 51 may be formed of a material including portions with an amorphous structure. The more the amorphous portion in the light-absorbing layer 51, the higher the energy bandgap of the light-absorbing layer 51. Or, the less the amorphous portion in the light-absorbing layer 51, the lower the energy bandgap of the light-absorbing layer 51.

In some embodiments, the light-absorbing layer 51 may be formed of the substantially same material and by the substantially same method as the light-absorbing layer 50 described with reference to FIG. 3. For example, the light-absorbing layer 51 may be formed of a silicon layer deposited using a PECVD method, and in this case, the content of the amorphous portion can be controlled by adjusting a flow ratio of a silane gas to a hydrogen gas (e.g., to have a range of 10 to 20). As shown in FIG. 7, in the case in which the light-absorbing layer 51 is formed of silicon, the energy bandgap thereof may be changed by the content of the amorphous portion therein, and this may lead to a change in the optical absorbance property of the light-absorbing layer 51.

The second electrode 70 may be formed on the light-absorbing layer 51 (Step S30). A protection layer 90 may be formed on the second electrode 70 (Step S40).

In some embodiments, the substrate 10, the first electrode 30, the second electrode 70, and the protection layer 90 may be formed of the substantially same material and by the substantially same method as those described with reference to FIG. 4 or 5.

### Third Embodiment

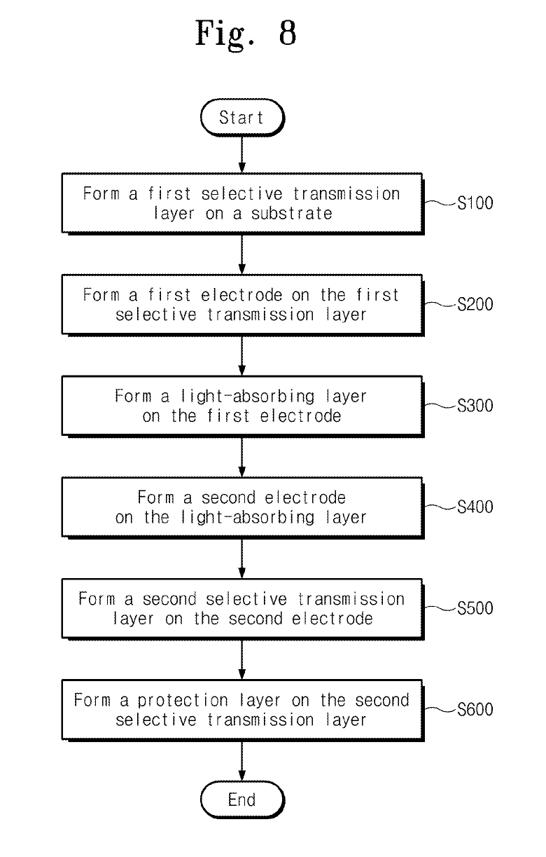

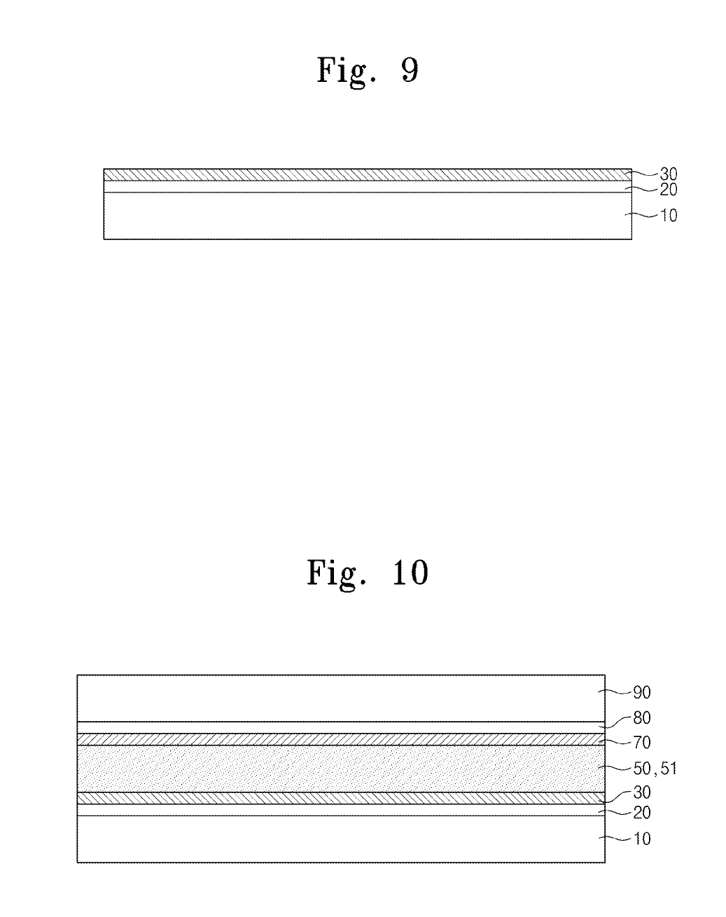

FIG. 8 is a flow chart illustrating a method of fabricating a solar cell according to other example embodiments of the inventive concepts, and FIGS. 9 and 10 are sectional views illustrating a method of fabricating a solar cell according to a third embodiment of the inventive concepts. Hereinafter, a method of fabricating a solar cell according to the third embodiment of the inventive concepts will be described with reference to FIGS. 8 through 10.

Referring to FIGS. 8 and 9, the substrate 10 may be provided. A first selective transmission layer 20 may be formed on the substrate 10 (Step S100). The first selective transmission layer 20 may be formed of a material having an energy bandgap of 2.5 eV or more. In some embodiments, the first selective transmission layer 20 may be formed of at least one of insulating materials, such as SiO₂, Al₂O₃, TiO₂, AlTiO or HfO₂. In other embodiments, the first selective transmission layer 20 may be formed of at least one of semiconductors, such as ZnO or Cu₂O. The first selective transmission layer 20 may be formed of a material exhibiting a partial transmission and partial reflection property for an incident light.

Referring to FIG. 8, the first electrode 30 may be formed on the first selective transmission layer 20 (Step S200). The light-absorbing layer 50 or 51 may be formed on the first electrode 30 (Step S300), and then, the second electrode 70 may be formed on the light-absorbing layer 50 or 51 (Step S400). The light-absorbing layer 50 or 51 may be formed to have the same technical features as that described with reference to FIGS. 1 through 6. Thereafter, a second selective transmission layer 80 may be formed on the second electrode 70 (Step S500).

The second selective transmission layer 80 may be formed of the substantially same material and by the substantially same method as the first selective transmission layer 20 described previously. A fraction of the incident light passing through the first selective transmission layer 20 may be incident to the second selective transmission layer 80 through the light-absorbing layer 50 or 51, and then be reflected to and absorbed by the light-absorbing layer 50 or 51. In some embodiments, the first and second selective transmission layers 20 and 80 may be configured in such a way that a light transmitting through the first selective transmission layer 20 can have the substantially same wavelength as a light reflected from the second selective transmission layer 80. In addition, optical thicknesses of the first and second selective transmission layers 20 and 80 may be controlled to adjust optical absorbance properties of the first and second selective transmission layers 20 and 80 according to a wavelength of an incident light. Here, the optical thickness may be given by a product of a physical thickness and a refractive index of the layer.

The protection layer 90 may be formed on the second selective transmission layer 80 (Step S600). In some embodiments, the substrate 10, the first electrode 30, the light-absorbing layer 50 or 51, the second electrode 70, and the protection layer 90 may be formed of the substantially same material and by the substantially same method as those described with reference to FIG. 4 or 5.

According to the afore-described example embodiments of the inventive concepts, an energy bandgap of the transparent light-absorbing layer 50 or 51 can be controlled to absorb a fraction of a light with a predetermined wavelength, and the remaining fraction of the light may be transmitted or reflected and be used to display a predetermined color. In some embodiments, the absorbed light may have a visible wavelength. A wavelength of the light absorbed by the light-absorbing layer 50 or 51 may be controlled by adjusting a composition ratio of elements constituting the light-absorbing layer 50 or a content of an amorphous portion of the light-absorbing layer 51. In some embodiments, the optical absorbance property of the light-absorbing layer 50 or 51 can be improved by forming the first and second selective transmission layers 20 and 80 on and below the light-absorbing layer 50 or 51.

According to example embodiments of the inventive concepts, a light-absorbing layer may be provided to absorb a light having a predetermined wavelength, and this enables to realize a solar cell capable of displaying a predetermined color.

While example embodiments of the inventive concepts have been particularly shown and described, it will be understood by one of ordinary skill in the art that variations in form and detail may be made therein without departing from the spirit and scope of the attached claims.

What is claimed is:

1. A method of fabricating a solar cell, comprising:
forming a first electrode on a substrate;
forming a light-absorbing layer on the first electrode, the light-absorbing layer having a composition ratio or an energy bandgap controlled to absorb a light with a predetermined wavelength; and
forming a second electrode on the light-absorbing layer.

2. The method of claim 1, wherein the light-absorbing layer is formed of at least one of silicon, silicon nitride, silicon oxide, silicon carbide, or silicon germanium.

3. The method of claim 1, wherein the first and second electrodes are formed to have a thickness of about 200 nm to about 1000 nm.

4. The method of claim 1, further comprising, forming a first selective transmission layer between the substrate and the first electrode, wherein the first selective transmission layer allows a light in a predetermined range of wavelength to pass therethrough and transmit to the light-absorbing layer.

5. The method of claim 4, wherein the first selective transmission layer is formed of a material having an energy bandgap of 2.5 eV or more.

6. The method of claim 5, wherein the first selective transmission layer is formed of at least one of SiO₂, Al₂O₃, TiO₂, AlTiO, or HfO₂.

7. The method of claim 1, further comprising, forming a second selective transmission layer on the second electrode, wherein the second selective transmission layer allows a light in a predetermined range of wavelength to pass therethrough and be incident to the second electrode.

8. The method of claim 7, wherein the second selective transmission layer is formed of a material having an energy bandgap of 2.5 eV or more.

9. The method of claim 8, wherein the second selective transmission layer is formed of at least one of SiO₂, Al₂O₃, TiO₂, AlTiO, or HfO₂.

10. A method of fabricating a solar cell, comprising:
forming a first electrode on a substrate;
forming a light-absorbing layer including an amorphous portion on the first electrode, the light-absorbing layer having a content of the amorphous portion or an energy bandgap controlled to absorb a light with a predetermined wavelength; and
forming a second electrode on the light-absorbing layer.

11. The method of claim 10, wherein the light-absorbing layer comprises a crystalline silicon portion and an amorphous silicon portion, and a content ratio of the crystalline silicon portion to the amorphous silicon portion is controlled in such a way that an energy bandgap of the light-absorbing layer is in a range from about 0.7 eV to about 2.5 eV.

12. The method of claim 10, further comprising forming a first selective transmission layer between the substrate and the first electrode.

13. The method of claim 12, wherein the first selective transmission layer is formed of a material having an energy bandgap of 2.5 eV or more.

14. The method of claim 13, wherein the first selective transmission layer is formed of at least one of SiO₂, Al₂O₃, TiO₂, AlTiO, or HfO₂.

15. The method of claim 10, further comprising forming a second selective transmission layer on the second electrode.

16. The method of claim 15, wherein the second selective transmission layer is formed of a material having an energy bandgap of 2.5 eV or more.

17. The method of claim 16, wherein the second selective transmission layer is formed of at least one of SiO₂, Al₂O₃, TiO₂, AlTiO, or HfO₂.
